(19) United States
(12) Patent Application Publication
(10) Pub. No.: US 2012/0079686 A1
(43) Pub. Date: Apr. 5, 2012

(54) REMOTE CONTROL HANDLE

(76) Inventor: Teserita V. Hutcheson, Charleston, SC (US)

(21) Appl. No.: 12/897,170

(22) Filed: Oct. 4, 2010

(51) Int. Cl. B25G 3/00; B25G 1/00

(52) U.S. Cl. 16/422

(57) ABSTRACT

A remote control comprises a handle. The handle is formed as an elongated member that is positioned generally parallel to the length of the remote control. The elongated member has a length that exceeds the length of the remote control. An upper end of the elongated member extends beyond a top surface of the remote control and a lower end of the elongated member extends beyond a bottom surface of the remote control. An enlarged member is attached at the top of the elongated member to form a handle. The elongated member is attached to the remote control by a first band and a second band which surround both the remote control and the elongated member to hold the elongated member in place.

### FIELD OF THE INVENTION

This invention relates generally to remote controls, and is more specifically addressed to a remote control having a handle that is attached to the remote control.

### BACKGROUND OF THE INVENTION

Remote controls for electrical and electronic devices are in widespread use. Substantially all mass marketed consumer electronic devices are delivered with a remote control. Such consumer electronic devices include audio and video devices, such as amplifiers, CD players, DVD players, and televisions. However, many electrical and electronic devices for home use, including controls for window coverings and lighting devices, have remote controls.

Remote controls are characterized by a case, which is usually plastic, having a plurality of buttons to allow the user to control a device or multiple devices. Various features of the electrical and electronic devices may be operated by pressing one or more buttons.

The case in which the remote controls are housed generally have a length that exceeds the width. Remote controls are relatively thin, and generally do not exceed 2 cm. The shape of remote controls is such that remote controls are easily misplaced. Remote controls may become lodged between upholstered furniture and cushions for the upholstered furniture. A remote control may be misplaced underneath objects due to its size and shape, and the remote control may be difficult to find.

There is a need for a device that will impair the ease with which remote controls are misplaced. It is preferred that such device be useful as a handle. It is also desired that the device be universally used with existing remotes.

### SUMMARY OF THE INVENTION

The present invention is a remote control comprising a handle. The handle is formed as an elongated member that is positioned generally parallel to the length of the remote control. The elongated member has a length that exceeds the length of the remote control. An upper end of the elongated member extends beyond a top surface of the remote control and a lower end of the elongated member extends beyond a bottom surface of the remote control. An enlarged member is attached at the top of the elongated member to form a handle. The elongated member is attached to the remote control by a first band and a second band which surround both the remote control and the elongated member to hold the elongated member in place.

### DESCRIPTION OF THE DRAWINGS

FIG. 1 shows a top plan view of a remote control comprising a handle according to an embodiment of the invention.

FIG. 2 demonstrates an embodiment of the elongated member, with a plurality of enlarged members which may be attached to the elongated member.

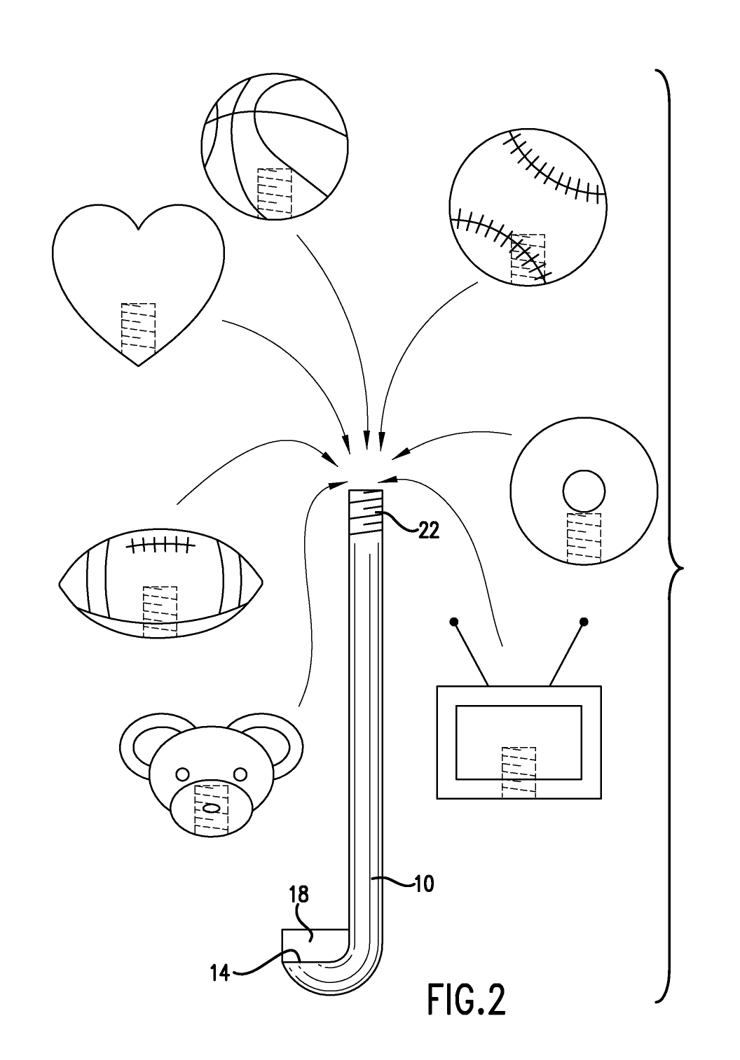

FIG. 3 is a top plan view of an additional embodiment of the remote control according to the invention.

### DETAILED DESCRIPTION OF PREFERRED EMBODIMENTS

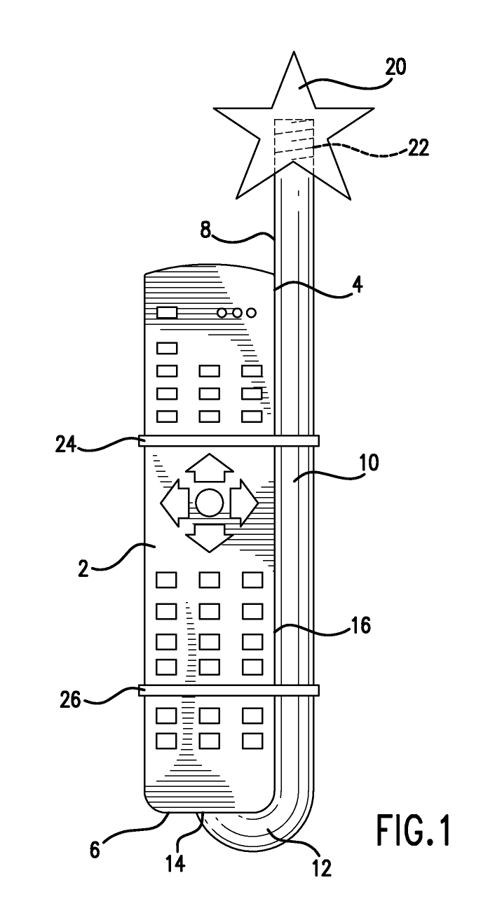

FIG. 1 shows a remote control 2. The remote control has a length that exceeds the width. The remote control in this embodiment has a side 4, a portion of which is generally flat along its length from about the top of the remote control to about the bottom of the remote control. The bottom of the remote control has a portion 6 that is generally flat along its length.

Also as shown in FIG. 1 is an elongated member 10. The elongated member is preferred to extend along a side of the remote control as shown in FIG. 1. The elongated member is preferred to be directly adjacent to the flat side 4 of the remote control. The elongated member is preferred to have a length that exceeds the length of the length of the remote control. A portion of the elongated member is preferred to extend above the top of the remote control at one end of the elongated member, and extend below the bottom of the remote control at an opposite end of the elongated member.

As shown in the embodiment of FIG. 1, the elongated member has a curved or arcuate portion 12 that curves away from the elongated portion of the elongated member and toward the remote control. In the embodiment shown, the curved portion curves substantially 180°, and provides a flat surface 14 against which the flat portion 6 of the bottom of the remote control rests. In one embodiment, a backing 18 extends generally 90° from the flat surface 14.

The elongated member may be formed of wood, metal, plastic or other suitable material. The elongated member may be formed of a plastic comprising light-absorbing material, so that the elongated member glows in the dark. This feature assists in finding the remote control in the dark.

The elongated member may be coated or covered with a material having a high coefficient of friction. The elongated member may have an outer surface of rubber or foam that that will deform to grip the remote control and prevent slippage at the contact point between the remote control and the elongated member. Further, the deformable or compressible material will retard slippage of the bands.

In one embodiment, the elongated member does not have a thickness or diameter that would cause the elongated member to extend beyond the top face 28 of the remote control or below the bottom surface of the remote control that is opposite the face.

In an embodiment, the cross-section of the elongated member is generally circular. In another embodiment, the cross-section of the elongated member is generally rectangular, or square. In another embodiment, the side 8 of the elongated member that adjoins the side 4 of the remote control is generally flat, with the side opposite the flat surface being generally arcuate. A flat surface of the elongated member that adjoins the remote control assists in providing increased surface contact between the elongated member and the remote control, when compared with a round surface, and assists in holding the elongated member in place against the remote control. One or more adhesive strips 16 may be provided to adhere the elongated member to the remote control along the side of the elongated member, and/or to adhere the bottom of the remote control to the flat surface provided by the arcuate portion of the elongated member as shown n FIG. 1.

An enlarged member 20 is provided at the top of the elongated member. The enlarged member extends above the top of the remote control. The enlarged member is preferred to be a decorative design. The enlarged member may be mounted to the elongated member by providing a void into which the elongated member extends. The enlarged member may be permanently attached, such as by gluing or welding the enlarged member. However, in a preferred embodiment, and as shown in the drawing figures, a threaded engagement 22 between the enlarged member and the elongated member is provided. A threaded engagement allows multiple decorative designs for the enlarged member to be provided and easily switched according to the user's taste and preferences. The decorative design may correspond to a television show being watched, such as sporting events, children's events or children's shows. The decorative design may correspond to the device which the remote control controls, such as a DVD player or a television. The decorative design may correspond to the user's favorite sports teams, or a representation of the user's favorite actor or cartoon character. Many other shapes and designs may be employed. The enlarged head may have a blunt end for safety reasons.

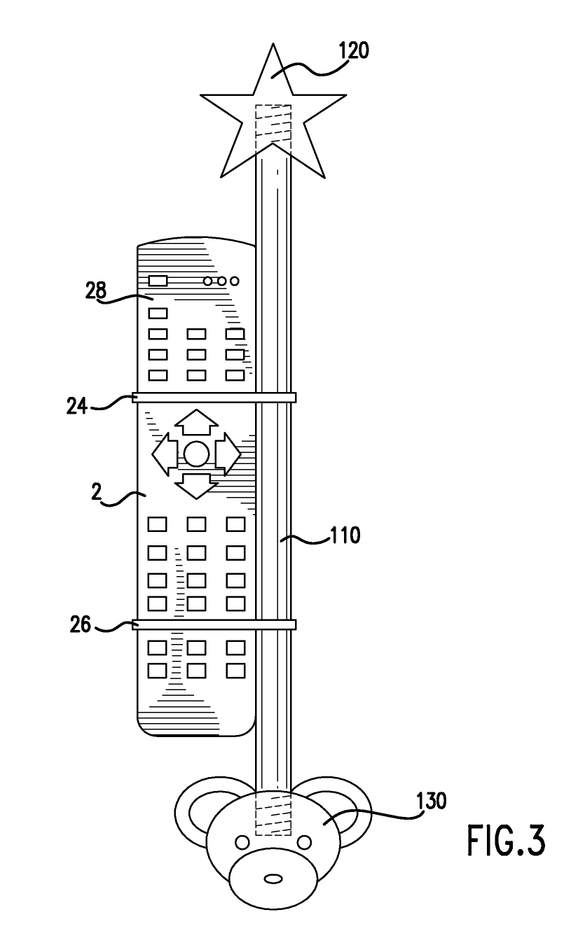

In the embodiment shown in FIG. 3, an enlarged member 120 is present at the top of the elongated member and an enlarged member 130 is present at the bottom of the elongated member 110. The enlarged members may be decorative selected devices according to the user's taste and preference.

The elongated member and the enlarged member comprise the handle. The handle may be affixed to existing remote controls on an after-market basis. The handle may be joined to the remote control as shown in FIG. 1 and FIG. 3 by the use of bands. The bands hold the elongated member against one side of the length of the remote control in the embodiments shown. A first band 24 and second band 26 are preferred to be provided. The bands are positioned on the remote control so as to not interfere with the operation of the buttons or switches on the remote control. The bands may be ratchet-type ties that pull the handle tightly against the remote control and, once in place, can only be removed by cutting the bands.

Alternatively, the bands may comprise an elastic or rubberized material that is stretched to position the bands and the handle, with the elastic properties of the band holding the handle in place. The elastic bands are potentially reusable.

It is preferred that the elongated member be positioned tightly against the remote control so that the elongated member does not rotate, and the elongated member remains in a generally parallel relationship with the remote control, with the elongated member not extending materially above or below the top face and opposite bottom surface of the remote control. The elongated member should not “wiggle” relative to the remote control.

The resulting handle effectively increases the length of the remote control. The additional length makes the remote control less likely to fall into cracks and crevices, and makes the remote control easier to see if the remote control is mixed in with other objects, or is under other objects. Similarly, the enlarged member at the top and, if used, the enlarged member at the bottom, provide an additional enlarged object that prevents the remote control from falling into cracks and crevices, and which makes the device easier to spot. If the decorative enlarged members are painted or colored with vibrant colors, then the remote control is easier to see, with the unique design the decorative object providing a visual reference for the user. The enlarged members may be formed of plastics that will absorb light, and glow in the dark. Likewise, the bands may be formed of light absorbing plastic that will glow in the dark. The bands may be formed in various colors.

What is claimed is:

1. A remote control, comprising:
a) a remote control having a length of the remote control exceeding a width of the remote control;
b) an elongated member that is positioned generally parallel to the length of the remote control, wherein the elongated member has a length that exceeds the length of the remote control, wherein an upper end of the elongated member extends beyond a top surface of the remote control and a lower end of the elongated member extends beyond a bottom surface of the remote control, and wherein the upper end of the elongated member comprises threads;
c) an enlarged member comprising a threaded opening therein, wherein the enlarged member has a width that exceeds a width of the elongated member and the enlarged member is attached to the upper end of the elongated member by the threaded opening receiving the threads of the elongated member, and wherein the enlarged member extends above the upper end of the elongated member; and
d) a first band and a second band, wherein the first band and the second band surround the remote control and the elongated member and, in use, the first band and the second band hold the length of the remote control and the length of the elongated member in a substantially parallel relationship.

2. A remote control as described in claim 1, a second enlarged member comprising a threaded opening therein, wherein the second enlarged member has a width that exceeds a width of the elongated member and the second enlarged member is attached to the lower end of the elongated member by the threaded opening receiving threads formed on the lower end of the elongated member and wherein the second enlarged member extends below the lower end of the elongated member

3. A remote control as described in claim 1, wherein the lower end of the elongated member has an arcuate shape that curves at substantially 180 degrees and below a lower end of the remote control and toward the remote control, and the lower end of the elongated member contacts a bottom surface of the remote.

4. A remote control as described in claim 1, wherein the elongated member is formed of light absorbing material.

5. A remote control as described in claim 1, wherein the enlarged member is formed of light absorbing material.

6. A remote control as described in claim 1, wherein the elongated member comprises a flat side that contacts a flat side of the remote control.

7. A remote control as described in claim 1, wherein the elongated member comprises a rectangular cross section and comprises a flat side that contacts a flat side of the remote control.

8. A remote control as described in claim 1, wherein the elongated member comprises a square cross section and comprises a flat side that contacts a flat side of the remote control.

9. A remote control as described in claim 1, wherein the elongated member comprises an adhesive on a side of the elongated member that contacts a side of the remote control.

10. A remote control as described in claim 1, wherein the enlarged member joins the elongated member by threaded engagement.

11. A remote control as described in claim 1, wherein the remote control comprises a plurality of enlarged members and the plurality of enlarged members join the elongated member by threaded engagement.

12. A remote control as described in claim 1, wherein the remote control comprises a plurality of enlarged members.

13. A remote control as described in claim 1, wherein the first band is formed of light absorbing material.

14. A remote control as described in claim 1, wherein the width of the elongated member is constructed and arranged to not extend beyond a top face of the remote or beyond a bottom surface of the remote that is opposite the top face of the remote.

15. A remote control as described in claim 1, wherein the enlarged member is a decorative device that comprises multiple colors.

16. A remote control as described in claim 1, wherein the enlarged member is a decorative device that comprises a full color design.

17. A remote control as described in claim 1, wherein an outer surface of the elongated member comprises a compressible material, and wherein the first band is tightened against the elongated member to compress the compressible material.

18. A remote control as described in claim 1, wherein an outer surface of the elongated member comprises a rubberized material, and wherein the first band is tightened against the elongated member to compress the rubberized material.

19. A remote control as described in claim 1, wherein an outer surface of the elongated member comprises a foam material, and wherein the first band is tightened against the elongated member to compress the foam material.
